(19) United States
(12) Patent Application Publication
(10) Pub. No.: US 2002/0026628 A1
(43) Pub. Date: Feb. 28, 2002

(54) Pattern defect checking method and device

(76) Inventor: Ryoichi Matsuoka, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 09/934,005

(22) Filed: Aug. 20, 2001

(30) Foreign Application Priority Data
Aug. 25, 2000 (JP) 2000-254969

(51) Int. Cl. G06F 17/50

(52) U.S. Cl. 716/21

(57) ABSTRACT

In order to check for defects in a pattern of an exposure mask, a pattern signal S3 is acquired based on secondary electrons 2Ba acquired by two dimensional scanning of the exposure mask M by an electron beam scanning device 2, and a CAD signal S4 corresponding to a CAD graphic is acquired, and synchronized with output of the pattern signal S3 based on CAD data DT for the pattern of the exposure mask M. Defects in the pattern of the exposure mask M are checked for based on comparison results of the mask signal S3 and the CAD signal S4.

### BACKGROUND OF THE INVENTION

1. Field of the Invention

The present invention relates to a pattern defect checking method that checks for defects in a pattern such as a wafer pattern or a mask pattern using CAD data.

2. Description of the Prior Art

In manufacturing processes for various semiconductors, it is necessary to check whether or not a mask pattern used in a patterning process or a wafer pattern formed on a semiconductor wafer has been formed correctly in a specified condition. When performing this type of pattern defect check, methods adopted in the related art include a method of checking defects by acquiring a wafer pattern to be checked using an electron microscope or the like, or an optical image or an SEM image of a mask pattern, and comparing the image of a pattern to be checked acquired in this way with a specified reference image, or a method of preparing CAD data used to make a wafer pattern or mask and performing defect checking by comparing the pattern image to be checked with a CAD pattern image from CAD data.

However, in the case of realizing an ultra fine process to form a mask pattern on a large wafer of about 20 cm diameter, for example, the number of these patterns will be enormous. As a result, if defect checking of the wafer or mask pattern is carried out using the related art method described above, as well as the fact that data acquisition of the mask images to be checked takes a lot of time, data transmission of the acquired pattern image and image data comparison also require a lot of time. Accordingly, the overall checking time becomes extremely long, and in particular, there is a problem that this is not realistic in adopting production processes required to start up short term mass production.

### SUMMARY OF THE INVENTION

An object of the present invention is to provide a pattern defect checking method and device that can be expected to increase the speed of defect checking of a wafer or mask pattern in order to solve the above described problems of the related art.

In order to solve the above problems, with the present invention, a pattern signal corresponding to a pattern shape is acquired based on secondary electrons acquired by two dimensional scanning of a pattern to be checked using an electron beam, the pattern signal is compared with a CAD signal corresponding to CAD graphics for making the pattern, and checking for defects in the pattern is performed based on the comparison results.

According to the present invention, there is provided a pattern defect checking device for checking defects in a pattern such as a wafer pattern or a mask pattern, comprising an electron beam scanning device for two dimensional scanning of a pattern to be checked using an electron beam in response to a given scanning signal, pattern signal output means for outputting a pattern signal corresponding to a pattern shape based on secondary electrons acquired by scanning of the electron beam, CAD signal output means for outputting a CAD signal representing a required pattern shape, in synchronism with output of the pattern signal, based on CAD data for making the pattern, and comparison means for comparing the pattern signal and the CAD signal, wherein defects in the pattern are checked based on output from the comparison means.

The CAD signal output means can synchronize the mask signal and the CAD signal based on the scanning signal.

It is also possible for the CAD data to be stored in memory, and for the CAD signal output means to output the CAD signal by reading CAD data, for coordinate positions according to a coordinate signal representing coordinates for scanning points of the electron beam acquired based on the scanning signal, from the memory.

It is also possible for the pattern signal output means to comprise a secondary electron detector for detecting the secondary electrons, and a sensitivity regulator for comparing an output signal from the secondary electron detector with a reference signal of a given fixed level to acquire the pattern signal. Further, it is possible to extract mismatch information of the pattern signal and the CAD signal from the comparison means as a defect signal, and to store the defect signal extracted in this way in memory.

According to the present invention, there is also provided a pattern defect checking method, for checking defects in a pattern such as a wafer pattern or a mask pattern, comprising the steps of acquiring a pattern signal corresponding to a pattern shape based on secondary electrons acquired by two dimensional scanning of a pattern to be checked using an electron beam, comparing the pattern signal with a CAD signal corresponding to CAD graphics for making the pattern, and checking for defects in the pattern based on the comparison results.

In this case, the pattern signal and the CAD signal can be synchronized based on a scanning signal for two dimensional scanning of an electron beam.

### BRIEF DESCRIPTION OF THE DRAWINGS

FIG. 1 is a schematic diagram showing one example of an embodiment of a pattern defect checking device of the present invention.

FIG. 2A is the level of X direction scanning signal S1X.

FIG. 2B is the level of Y direction scanning signal S1Y.

FIG. 3A represents part of the pattern of the exposure mask M.

FIG. 3B represents the output signal S2 acquired when the pattern section is scanned in the X direction as shown by the dotted line P in the drawing using the electron beam 2B.

FIG. 3C represents the pattern signal S3 acquired varying in level in a binary manner in response to the pattern shape shown by FIG. 3A.

FIG. 3D represents a CAD graphic which is the pattern shape estimated based on the CAD data DT.

FIG. 3E represents the waveform of the CAD signal S4.

FIG. 3F represents the defect signal S6.

FIG. 4 is a drawing showing one example of checking result data.

### DETAILED DESCRIPTION OF THE PREFERRED EMBODIMENTS

An example of an embodiment of the present invention will now be described in detail, with reference to the drawings.

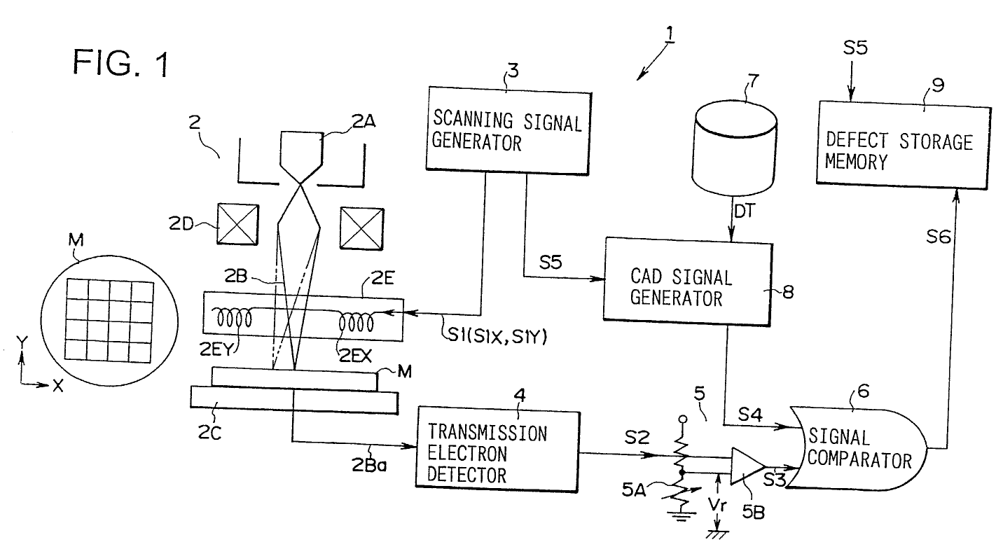

FIG. 1 is a schematic diagram showing one example of an embodiment of a pattern defect checking device of the present invention. The pattern defect checking device 1 is a device for checking defects in various ultra fine patterns such as a wafer pattern or a mask pattern of an exposure mask, and is provided with an electron beam scanning device 2 for two dimensional scanning of a pattern to be checked using an electron beam. With this embodiment, an example will be described for a case of performing defect checking for a pattern of an exposure mask used in a masking process, but the present invention is not thus limited. The electron beam scanning device 2 has a well known structure comprising an electron gun 2A, an electron lens 2D for focusing an electron beam 2B from the electron gun 2A on an exposure mask M mounted on a sample table 2C, and a deflector 2E for deflecting the electron beam 2B for two dimensional scanning of the exposure mask M that is to be measured using the electron beam 2B in X and Y directions, and a scanning signal S1 from a scanning signal generator 3 is provided to the deflector 2E.

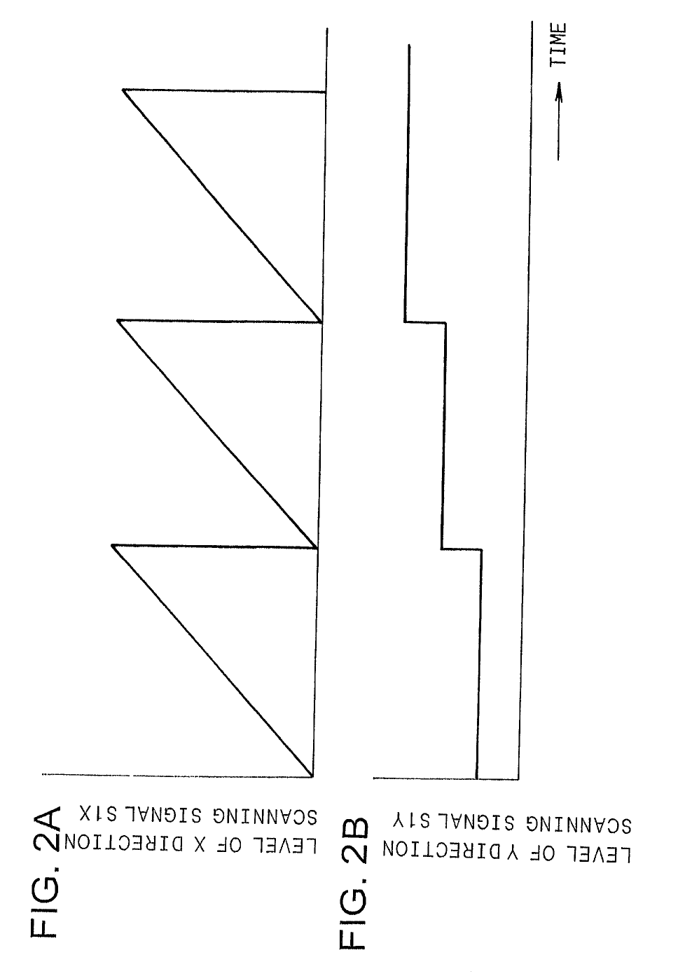

As shown in FIG. 2, the scanning signal S1 is made up of an X direction scanning signal S1X and a Y direction scanning signal S1Y, the X direction scanning signal S1X and the Y direction scanning signal S1Y are respectively applied to an X direction deflector coil 2EX and a Y direction deflector coil 2EY of the deflector 2E, and in this way the electron beam 2B is deflected and the exposure mask M is two dimensionally scanned in the X and Y directions.

The electron beam exposure mask M, as exemplified in FIG. 1, has a well known structure where a required mask pattern is formed on a circular transparent glass substrate, and secondary electrons 2Ba, generated by two dimensional scanning of the exposure mask M with the electron beam 2B in accordance with a scanning signal S1, are detected by a secondary electron detector 4. The secondary electrons 2Ba have information of the mask pattern of the exposure mask M, and a mask pattern of the exposure mask M, namely an output signal S2 appropriate to the mask shape, is output from the secondary electron detector 4, this output signal S2 being used for sensitivity regulation in the sensitivity regulator 5. With the embodiment shown in FIG. 1, the sensitivity regulator 5 performs voltage comparison of the level of the output signal S2 with a reference voltage acquired by a variable resistive potential divider circuit 5A using the voltage comparator 5B, and this comparison output is output as a mask signal S3.

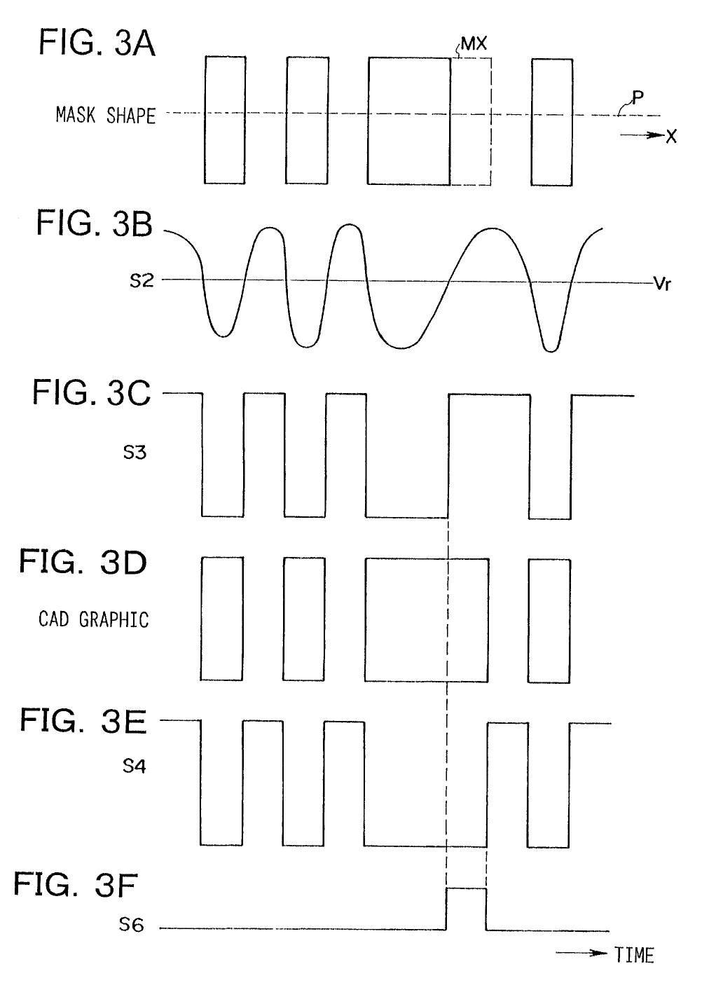

Operation of the sensitivity regulator 5 will now be described with reference to FIG. 3. FIG. 3A represents part of the pattern of the exposure mask M, and an output signal S2 acquired when this pattern section is scanned in the X direction as shown by the dotted line P in the drawing using the electron beam 2B is represented by FIG. 3B. The output signal S2 is a signal from secondary electrons acquired by scanning the pattern of FIG. 3A, and so the level of the signal S2 varies according to the mask shape. The output signal S2 is subjected to level comparison, by the voltage comparator 5B with a reference voltage Vr having a level appropriately set by a potential divider circuit 5A. In this way, the output signal S2 is subjected to waveform shaping, and as shown by FIG. 3C a pattern signal S3 is acquired varying in level in a binary manner in response to the pattern shape shown by FIG. 3A. As will be understood from the above description, by adjusting the level of the reference voltage Vr, it is possible to make a correspondence relationship between the pattern signal S3 and the pattern shape appropriate.

Returning to FIG. 1, the pattern signal S3 acquired as described above, and being an electrical signal corresponding to the actual pattern of the exposure mask M, is input to one input of a signal comparator 6. In order to check whether or not the actual pattern is formed as planned using the pattern signal S3, that is, to check whether or not there are defects in the actual pattern, a CAD signal S4 formed based on CAD data DT used to make the exposure mask M stored in the memory 7 is supplied from the CAD signal generator 8 to the other input of the signal comparator 6.

In order to acquire synchronization of the CAD signal S4 with the pattern signal S3 from the CAD data DT stored in the memory 7, a coordinate signal S5 is input to the CAD signal generator 8 from the scanning signal generator 3. The coordinate signal S5 is formed inside the scanning signal generator 3 based on the scanning signal S1, and represents coordinates of scanning points of the electron beam 2B for scanning using the scanning signal S1 at that time. At the CAD signal generator 8, CAD data for coordinate positions represented by this coordinate signal S5 are read from the memory 7 and output as the CAD signal S4, and in this way the pattern signal S3 and the CAD signal S4 are synchronized.

Referring to FIG. 3, FIG. 3D represents a CAD graphic, being the pattern shape estimated based on the CAD data DT. Accordingly, the waveform of the CAD signal S4 is as shown in FIG. 3E. The pattern signal S3 and the CAD signal S4 are input to the signal comparator 6, and the levels of these signals are compared. If the levels of the two signals S3 and S4 match, the output of the signal comparator 6 is a low level, but the levels of the two signals S3 and S4 do not match, the output is a high level. Accordingly, with the embodiment shown in FIG. 3, as shown in FIG. 3A, the output of the signal comparator 6 is at a high level at portions where the two signals S3 and S4 do not match corresponding to missing portions MX that are missing from the actual pattern shape.

Thus a defect signal S6 that is a high level only at portions where there are defects in the pattern shape of the exposure mask is output from the signal comparator 6, and check result data according to the defect signal S6 are stored in the defect storage memory 9.

With this embodiment, the coordinate signal S5 is supplied to the defect storage memory 9, whether or not there is a defect is determined for coordinate positions on the exposure mask M sequentially represented by the coordinate signal S5 using information from the defect signal S6, and defect result data is store as data of “0” or “1”.

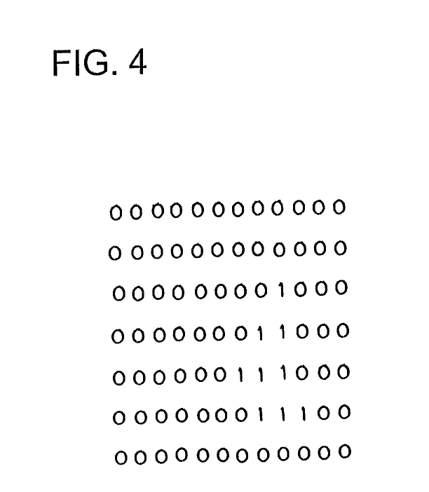

FIG. 4 shows one example of check result data acquired in this way. The check result data is allocated for all the coordinate points of the exposure mask M, and is “0”, if there is no defect and “1” if there is a defect. Accordingly, by displaying this check result data on a display device, not shown, it becomes possible to immediately ascertain where defects have arisen on the exposure mask M.

Since the mask defect checking device 1 is constructed as described above, there is no need to acquire an optical image of the pattern of the exposure mask M, and it is possible to promptly and accurately check whether or not there are defects in the exposure mask M using a pattern signal and a CAD signal based on secondary electrons acquired using electron beam scanning. Accordingly, in pattern checking for an extremely fine exposure mask, it is possible to realize high throughput, and it is possible to realize a reduction in the burden of checking cost in a mask pattern process. A description has been given above for the case of defect checking for a pattern of an exposure mask, but it is possible to efficiently perform all similar types of wafer pattern defect checking, and similar advantages can be obtained.

According to the present invention, as described above, there is no need to acquire an optical image of the pattern to be checked, and it is possible to promptly and accurately check whether or not there are defects in the pattern using a pattern signal and a CAD signal based on secondary electrons acquired using electron beam scanning of the pattern. Accordingly, in extremely fine pattern checking for a wafer or a mask, it is possible to realize high throughput, and it is possible to realize a reduction in the burden of checking cost in a pattern checking process.

What is claimed is:

1. A pattern defect checking device for checking defects in a pattern such as a wafer pattern or a mask pattern, comprising:
an electron beam scanning device for two dimensional scanning of a pattern to be checked using an electron beam in response to a given scanning signal;
pattern signal output means for outputting a pattern signal corresponding to a pattern shape based on secondary electrons acquired by scanning of the electron beam;
CAD signal output means for outputting a CAD signal representing a required pattern shape, in synchronism with output of the pattern signal, based on CAD data for making the pattern; and
comparison means for comparing the pattern signal and the CAD signal, wherein defects in the pattern are checked based on output from the comparison means.

2. The pattern defect checking device of claim 1, wherein the CAD signal output means synchronizes the mask signal and the CAD signal based on the scanning signal.

3. The pattern defect checking device of claim 1, wherein the CAD data is stored in memory, and the CAD signal output means outputs the CAD signal by reading CAD data for coordinate positions according to a coordinate signal representing coordinates for scanning points of the electron beam acquired based on the scanning signal, from the memory.

4. The pattern defect checking device of claim 1, wherein the pattern signal output means comprises a secondary electron detector for detecting the secondary electrons, and a sensitivity regulator for comparing an output signal from the secondary electron detector with a reference signal of a given fixed level to acquire the pattern signal.

5. The pattern defect checking device of claim 1, wherein mismatch information of the pattern signal and the CAD signal from the comparison means is taken out as a defect signal.

6. The pattern defect checking device of claim 5, wherein the defect signal is stored in memory.

7. A pattern defect checking method for checking defects in a pattern such as a wafer pattern or a mask pattern, comprising tie steps of
acquiring a pattern signal corresponding to a pattern shape based on secondary electrons acquired by two dimensional scanning of a pattern to be checked using an electron beam, comparing the pattern signal with a CAD signal corresponding to CAD graphics for making the pattern, and checking for defects in the pattern based on the comparison results.

8. The pattern defect checking method of claim 7, wherein the pattern signal and the CAD signal are synchronized based on a scanning signal for two dimensional scanning of the electron beam.
